(19) United States
(12) Patent Application Publication
(10) Pub. No.: US 2013/0014960 A1
(43) Pub. Date: Jan. 17, 2013

(54) Equine Protective Traction Device

(71) Applicants: Alissa M. Palmer, Kalispell, MT (US); Tyson C. Palmer, Kalispell, MT (US)

(72) Inventors: Alissa M. Palmer, Kalispell, MT (US); Tyson C. Palmer, Kalispell, MT (US)

(21) Appl. No.: 13/244,591

(22) Filed: Sep. 25, 2011

Related U.S. Application Data
(60) Provisional application No. 61/508,580, filed on Jul. 15, 2011.

(51) Int. Cl. A01L 3/00; A01L 3/06

(52) U.S. Cl. 168/1

(57) ABSTRACT

A removable equine shoe for temporary use in icy or slippery conditions comprised of a durable elastomeric compound that provides particular anatomical protection to an animal's hoof, and the shoe being affixed to the hoof by slightly deforming the shoe sidewalls in order to structurally wrap the shoe around the sides and impinge on the hoof wall, and with the sole of the shoe supporting traction studs strategically placed under hoof pressure points.

### CROSS-REFERENCE TO RELATED APPLICATIONS

This application claims the benefit of provisional patent application No. 61/508,580, filed 15 Jul. 2011 by the present inventors, Alissa Palmer and Tyson Palmer.

### STATEMENT REGARDING FEDERALLY SPONSORED RESEARCH OR DEVELOPMENT

Not Applicable

### BACKGROUND OF THE INVENTION

Metal shoes held in place by nails have provided protection to hooves for centuries. Horse shoes protect and support the hoof while the animal engaged in activities beyond the natural of the hoof structure. Since each animal's hooves are uniquely shaped, and iron offered the advantages of being easily shaped, and durably affixable to the hoof with metal nails. Also, iron protects the hoof from chipping and increases the sole's distance from the ground.

A particularly hazardous situation is the presence of slippery surfaces. While steel shoes offer a horse a high degree of protection and support, they generally lack traction on hard surfaces, and are poor shock absorbers. Additionally, the require installation by a person possessing specialized skills, such as a professional farrier. Further, since iron shoes are installed with nails and causes some damage to the hoof, it is not good for the hoof to have the shoe frequently removed and reinstalled. Over time, attempts have been made to address these problems with varying degrees of success.

Equine boots, such as those provided in U.S. Pat. Nos. 5,692,569; 5,588,288; 5,528,885; 4,174,754; 3,732,929; and 3,703,209 provide various examples of alternative devices that address the issues of traction and shock absorption without the use of traditional horseshoes. Some of the general characteristics common to these devices are as follows. They are designed to provide for easy installation, and are primarily utilized to provide a temporary solution for a missing or thrown shoe. They fit over the hoof, and are generally made from solid rubber, or other synthetic material with treads on the sole portion. While useful temporarily, these devices are typically heavy and clumsy, and substantially detract from a horse's performance. In some cases, the added weight of these devices causes interference between the horse's limbs. Additionally, the typically awkward shape of these devices makes them difficult for riders to carry, despite the fact that carrying them as a field-based horseshoe replacement is one of principle reasons they are purchased.

Many equine boots also tighten around the hoof with closures that can be clogged, damaged or broken by rocks, debris, or rugged terrain. In addition to excessive weight and clumsy design, these devices also tend to rub the bulbs of the hoof heels. This may cause sensitivity, bleeding and lameness in the heel area, rendering the horse unusable. Equine boots come in a variety of sizes but in only one standard shape, making them extremely difficult to install and to properly conform to hooves that differ from the standard design. To address this flaw, silicone inserts and adhesives are used to keep some of these devices affixed to the hoof making them extremely difficult to remove. The materials typically used in equine boots make it difficult for horse owners to modify them.

Hard facing caulks were developed as further attempts to adapt steel shoes to situations where horses require traction. Hard facing is a method by which a farrier or skilled professional spreads expensive high carbon metal chips contained in an adhesive flux over a horseshoe's impact points. This extends the life of the shoe and may increase traction on hard surfaces. The primary problem with hard facing is localized shock for the prolonged duration of the shoes life. Over time the areas hoof beneath the hard facing begin to delaminate, increasing the chance of injury to an animal's joints, tendons, and ligaments.

Other types and variations of temporary animal shoes and animal shoes that provide improved tracking in slippery conditions include the following examples. U.S. Pat. No. 866,423 issued to Louis L. Bellatty on Sep. 17, 1907, discloses protective covering for the feet designed to afford a firm footing in places where the surface may otherwise permit slipping, wherein a member formed of interwoven metal links, rings, or scales is sized to enclose the foot or hoof, and form a sole therefore.

U.S. Pat. No. 3,236,310 issued to Carl F. Quick on Feb. 22, 1966, discloses a self-fitting boot-type horse shoe in the form of a cup-like shaped molded from synthetic resin having heat-shrinkable properties, wherein once a horse hoof is insert into the cup-like shape, heat is applied to the boot so that the boot shrinks around the hoof, securing holding onto the hoof with a compressive force.

U.S. Pat. No. 3,794,119 issued to Al Paiso and Jno R. Battle on Feb. 26, 1974, discloses a horse shoe constructed from a flexible covering contoured to fit substantially entirely over a horse's hoof. Fixed to the sides and upper rear part of the covering are three holding elements. A securement sling or band, carrying at least three attachment elements, is wrapped around the hoof back portion and opposing sides. The band is oriented to generally overlie the covering in a manner to permit the holding elements and attachment elements to become interlocked in order to firmly secure the covering onto the horse's hoof.

U.S. Pat. No. 3,952,807 issued to Guiseppe Cattaneo on Apr. 27, 1976, discloses a device to provide anti-snow and anti-ice protection for horses' hooves in which an insert is provided in the horse-shoe and part of the elastically deformable U-shaped insert conforming to and coextensive with the inside edge of a horseshoe and in resilient engagement with the sole of a horse's hoof is partly clamped between the horse-shoe and the sole of the hoof.

U.S. Pat. No. 4,444,269 issued to Geoffrey J. Laurent on Apr. 24, 1984, discloses an animal hoof cover characterized in that provided a base, a toe cap fixed to the base, and first and second fastener supports having tabs extending to either side thereof to which ties can be mounted for securing the hoof cover to an animals hoof.

U.S. Pat. No. 4,564,071 issued to James M. Lee on Jan. 14, 1986, discloses a nailess horse shoe having a cup shaped configuration open at the rear part, molded of a flexible polymeric material having a forwardly extending slot shaped opening in the bottom. A sponge rubber sole is provided on the lower surface on the bottom of the shoe and clamping or tightening members in the form of rod members extend between the lateral side walls and are provided with tightening nuts to draw the lateral side walls towards each other into clamping engagement onto the horse's hoof.

U.S. Pat. No. 5,533,575 issued to David W. Brown on Jul. 9, 1996, discloses an elastomeric shoe for attachment to an equidae hoof, having a peripheral configuration corresponding to the peripheral configuration of the sole of an equidae hoof and a cross section of substantially uniform thickness, wherein the shoe includes a tread and a ply, which has sufficient thickness and strength to hold any nails used to attach the shoe to a hoof. An open back configuration is disclosed a central void so that shoe does not contact the hoof frog.

U.S. Pat. No. 6,305,328 issued to Helmut Marquis on Oct. 23, 2001, discloses a hoof shoe that can be slipped over a hoof of an animal and has at least one base part approximately adapted to the hoof, on which base part is formed a side wall component adjustable to the hoof of the animal. On the inner side of the wall component is provided an elastically deformable material, which is at least partially surrounded by the wall and can be pressurized by the introduction of a fluid medium.

U.S. Pat. No. 6,694,713 issued to David Duncan MacDonald on Feb. 24, 2004, discloses an equine multi-purpose protector boot comprising (a) a sole member rigid enough to resist lateral movement of the hoof with an upwardly depending rim extending around its periphery at least at the toe and at each side, the inner surface of the rim being substantially vertical at least in the region of the sides, (b) at least one flexible side flap located at each side of the hoof, attached to or integral with the sole member, (c) an outer compressive cover provided with means to force the side flap into conformation with the shape of the hoof, and (d) a flexible heel member attached to the rear of the sole member, including at least one fastening strap adapted to pass around the pastern bone within the range of 2 to 3.5 cm above the coronary band.

It would be an addition to the field of art to have an easily installable and removable equine shoe for temporary use in icy or slippery conditions, comprised of a durable elastomeric compound that would provide particular anatomical protection to an animal's hooves. The shoe may be affixed to the hoof by slightly deforming the shoe sidewalls in order to structurally wrap the shoe around the sides and impinge on the hoof wall, and the sole of the shoe may support traction studs strategically placed under hoof pressure points.

### BRIEF DESCRIPTION OF THE DRAWINGS

The invention will be explained in conjunction with an illustrative embodiment shown in the accompanying drawings, in which:

FIG. 1 is a side view of an exemplary embodiment of the current invention;

FIG. 2 is a rear view of an exemplary embodiment of the current invention; and

FIG. 3 is a bottom view of an exemplary embodiment of the current invention.

FIG. 4 is a bottom view of an exemplary embodiment of the current invention depicting a periphery of the device.

### DESCRIPTION OF THE ILLUSTRATED EMBODIMENT

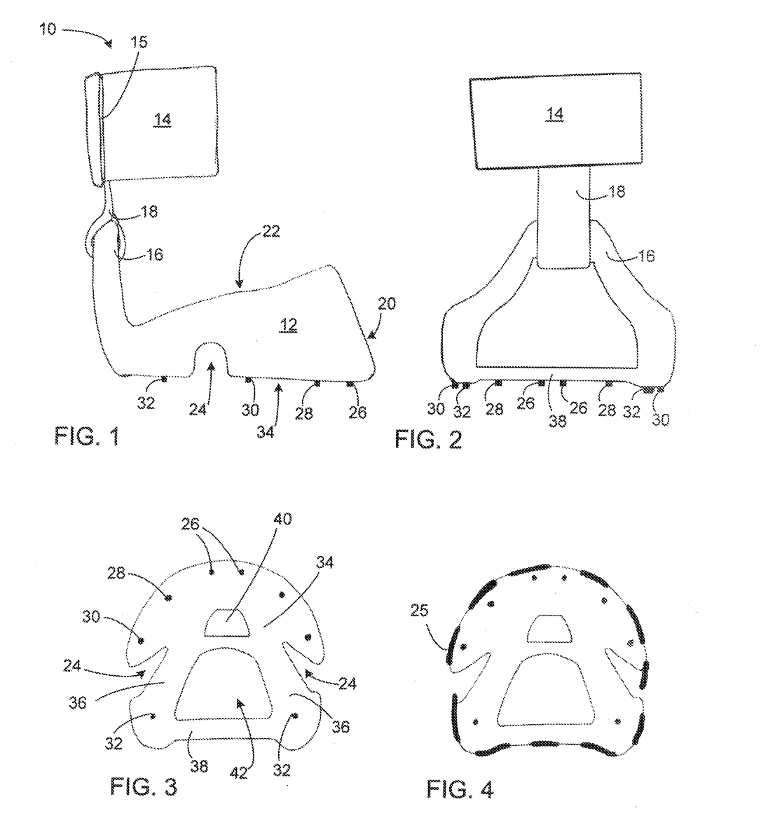

Now, referring to FIGS. 1 and 2, the exemplary temporary animal shoe 10 has a shoe body 12, a pastern cuff 14, a bulb loop 16, and a loop strap 18. The exemplary shoe body 12 may be formed from a durable elastomeric compound and shaped to correspond with the general shape of the intended animal's hoof wall structure (not shown). The exemplary shoe body 12 has a wall cover 20 that forms the sides of the shoe 10. The wall cover 20 is generally shaped to impinge on and hold securely against the curved front and sides of the particular hoof wall. A coronet rim 22 may be formed by the peripheral edge of the top of the wall cover 20.

In the exemplary embodiment a bulb loop 16 is formed at the rear of the shoe body 12. The bulb loop 16 may be formed from the same material as the shoe body 12, and may be integral to the shoe body 12. A combination of the pastern cuff 14 and loop strap 18 may be employed to draw the bulb loop 16 upward toward an animal's pastern (not shown), and thereby apply tension to the bulb loop 16, drawing the wall cover 20 of the shoe body 12 tightly against the hoof wall of the animal on which it is installed. In this fashion the shoe body 12 may be held securely in place on the hoof by either or both the shape of the wall cover 20 and the tension provided by the pastern cuff 14, loop strap 18, and bulb loop 16 connection. Wall cover 20 may have a quarter gap 24 on either or both sides, to permit flexibility in the shoe body 12, which may make installation and removal easier by providing space and slack for shoe 10 deformation. In an alternate embodiment, the bulb loop 16, and the loop strap 18 may be replaced with a shoe cinch structure that draws the shoe body 12 rearward on the hoof, toward the hoof bulb, and upward, toward the pastern cuff 14.

Pastern cuff 14 may be configured to hold securely to an animal's leg, intermediate the animal's ankle and hoof's coronets with a cuff fastener 15. A suitable cuff fastener 15 may be a hook and loop fastener or other suitable fasteners, such as, without limitation, a belt and buckle combination, or a frog and loop combination.

In the exemplary embodiment, the loop strap 18 is made from similar material as the pastern cuff 14, and one end is stitched to the pastern cuff 14 to provide secure attachment. The other end of the loop strap 18 is looped around a segment of the bulb loop 16 and then brought back against the body of the loop strap 18 and secured by stitching. Given this disclosure, other configurations could be devised that would similarly fall under the scope of this disclosure as a non-novel equivalent.

Now, additionally referring to FIGS. 3 and 4, the bottom of the shoe 10 forms a sole 34, which is part of the shoe body 12, and may be substantially attached to the bottom wall cover 20, opposite the coronet rim 22, around the periphery 25 of the sole 34. In the exemplary embodiment quarter gap 24 extends about half-way up the wall cover 20, and extends into the sole 34.

In the exemplary embodiment multiple studs 26, 28, 30, 32 positioned a functional distance from the periphery 25 of the sole 34, strategically under a sturdy part of the hoof wall structure on which the shoe 10 would be installed. In this application functional distance is a distance adequate to structurally support the studs 26, 28, 30, 32 in the sole 34 material, and can include being positioned on the periphery 25 if integrated into the sole 34 is a manner that would make it structurally sound for the intended purpose. The studs 26, 28, 30, 32 are securely anchored into various areas of the sole 34 where they may provide specific tractional requirements. The exemplary studs 26, 28, 30, 32 are generally cubical in shape, pointing away from the sole 34, and protruding generally about one-eighth inch out from the sole 34. The exemplary embodiment has toe studs 26 generally positioned to be under the toe of a hoof on which the shoe 10 would be installed. Additionally, the exemplary embodiment has heel studs 32 at the rear corners of the sole 34, quarter studs 30 generally at the sides of the sole 34, and intermediate studs 28 generally in between the quarter studs 30 and the toe studs 26. Studs having a generally conical shape may also be advantageous.

Each type of stud 26, 28, 30, 32 is placed in the specific areas around the hoof to maximize the weight of the animal to result in better traction during particular movements generally made by the animal. The toe studs 26 provide additional solid traction when pushing off, since animals apply greater pressure to the front area of the hoof when either or both starting or accelerating. Intermediate studs 28 and quarter studs 30 provide additional lateral support when the animal moves to change direction left or right. Heel studs 32 provide additional traction when the animal attempts to either or both stop or decelerate.

The front part of the sole 34, in the general vicinity of where the coffin bone of a hoof on which the shoe 10 would be worn would be located, has an apex hollow 40 formed by a thin are of material from which the shoe 10 is made. The exemplary apex hollow 40 provides a void in the shoe 10, so the shoe does not transfer pressure to the apex area of the frog, while still protecting the frog apex from debris, such as snow, ice, and rocks.

The rear part of the sole 34, in the general position of the balance of the frog, has a frog window 43, formed by lateral sole components 36 on the sides, and heel sole strip 38 to the rear. The lateral sole components 36 are formed between the frog window 42 and the quarter gaps 24. The heel studs 32 are located at the corner where each lateral sole 36 intersects the heel sole strip 38. Additionally, the opposite ends of the bulb loop 16 connect to opposite sides of the wall cover 20 and the sole 34 generally at the intersection of the particular lateral sole 36 and an end of the heel sole strip 38. In the exemplary embodiment the ends of the bulb loop 16 connect to the wall cover 20 and sole 34 far enough to the sides of the shoe 10 so that hoof bulbs of an animal wearing the shoe 10 would not be rubbed by the bulb loop 16. The heel sole strip 38 may be configured to provide cushion and traction between the hoof and the ground on which the animal walks.

The quarter gaps 24 and the bulb loop 16 assist in allowing the shoe 10 to be fitted to hooves of varying sizes. The wall cover 20 may be seen more clearly as a flexible portion, which is designed to either or both contract against and be bound against the hoof wall (not shown). In the exemplary embodiment, the wall cover 20 is angled inward in the direction of the coronet rim 22 in order to properly fit against the hoof wall (not shown). The actual angle of the wall cover 20 may vary around the circumference of the shoe 10 to provide a proper fit, and may be specifically tailored to a particular size range or type of animal. The flexibility of the material that forms the shoe body 12 enables a shoe 10 to be used for a variety of hooves. It may also be seen as important to ensure that the wall cover 20 does not extend excessively high on the hoof wall. If the coronet rim 22 is positioned at or above the hoof's coronet, the hoof could become irritated, causing rawness and hair loss.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A removable protective device for a hooved animal comprising:
a sole having a periphery and an posterior;
a bulb loop attached to the posterior of the sole; and
a pastern cuff connected to the bulb loop distal the sole.

2. The protective device of claim 1 wherein the sole further comprising:
studs positioned a functional distance from the periphery of the sole.

3. A removable protective device for a hooved animal comprising:
a sole having a periphery and an posterior;
a shoe wall comprising durable elastomeric compound that can support affixation to the hoof by slight deformation of the shoe wall in order to structurally wrap the shoe around, and impinge on the hoof wall;
a shoe cinch attached to the posterior of the sole; and
a pastern cuff connected to the shoe cinch distal the sole.

4. The protective device of claim 3 wherein the sole further comprising:
studs positioned a functional distance from the periphery of the sole.

5. The protective device of claim 4 wherein the sole further comprising:
at least one quarter gap.

6. The protective device of claim 5 wherein the sole further comprising:
an apex hollow.

7. The protective device of claim 6 wherein the sole further comprising:
a frog window.

8. The protective device of claim 3 wherein the sole further comprising:
at least one quarter gap.

9. The protective device of claim 8 wherein the sole further comprising:
studs positioned a functional distance from the periphery of the sole.

10. The protective device of claim 3 wherein the sole further comprising:
an apex hollow.

11. The protective device of claim 3 wherein the sole further comprising:
a frog window.

12. A process for protecting the hoof of an animal comprising:
deforming a removeable shoe device, comprising:
a sole having a periphery and an posterior;
a shoe wall comprising durable elastomeric compound that can support affixation to the hoof by slight deformation of the shoe wall in order to structurally wrap the shoe around, and impinge on the hoof wall; and
a shoe cinch attached to the posterior of the sole; and
tensioning the shoe cinch upward to draw the shoe wall against the hoof wall; and
securing a pastern cuff connected to the shoe cinch distal the sole to the animal's leg to maintain the tension in the shoe cinch.

13. The process of claim 12 further comprising:
positioning at least one stud, affixed to the sole a functional distance from the periphery of the sole, under a sturdy part of the hoof wall.
